(19) United States
(12) Patent Application Publication
(10) Pub. No.: US 2010/0128573 A1
(43) Pub. Date: May 27, 2010

(54) CLOCKWORK

(76) Inventors: Bernardus Johannes Meijer, s-Hertogenbosch (NL); Petrus Matheus Josephus Knapen, Tilburg (NL)

Correspondence Address: LADAS & PARRY LLP, 26 WEST 61ST STREET, NEW YORK, NY, 10023, US

(21) Appl. No.: 12/373,330

(22) PCT Filed: Jul. 5, 2007
(86) PCT No.: PCT/NL07/00170

§ 371 Date: Sep. 18, 2009

(30) Foreign Application Priority Data
Jul. 11, 2006 (NL) 1032149

(51) Int. Cl. G04B 1/00; G04B 15/00; G04B 5/02; G04F 5/00

(52) U.S. Cl. 368/127; 368/139; 368/160; 368/159; 368/208

(57) ABSTRACT

Mechanical clockwork assembly, comprising a drive mechanism, a mechanical control device comprising a mechanical oscillator and a first transmission device for providing a transmission between the drive mechanism and the mechanical oscillator, an electric generator and a second transmission device for providing a transmission between the drive mechanism and the generator, wherein the generator is spaced apart from the mechanical oscillator. In one embodiment the clockwork assembly comprises a sensor for determining a timing of the mechanical oscillator, an actuator for adapting a timing of the mechanical oscillator, an electronic control device connected to the sensor and the actuator, wherein the control device comprises an entry for a reference signal for controlling the timing of the mechanical oscillator on the basis of the reference signal, and wherein at least the control device is connected to the generator for supplying the control device with electric energy from the generator.

### BACKGROUND OF THE INVENTION

The invention relates to a mechanical clockwork assembly, comprising a drive mechanism, a mechanical oscillator and a first transmission device for providing a transmission between the drive mechanism and the mechanical oscillator. An example of such a transmission device comprises an escapement wheel and an anchor cooperating therewith, wherein the escapement wheel is operatively connected to the drive mechanism and the anchor is operatively connected to the mechanical oscillator.

Such a known clockwork assembly is particularly suitable for use in a wristwatch, wherein the drive mechanism comprises a resilient body for driving the clockwork. The watch may in that case be provided with a manual operating device, particularly a crown, for winding up the resilient body, and/or an eccentric pendulum weight which via a mechanical rectifier is connected to the resilient body for winding up the resilient body in case of a movement of the eccentric pendulum weight during wearing the watch.

A drawback of the known mechanical oscillators is that their timing is not sufficiently stable as a result of which watches provided with such a known clockwork have to be regularly adjusted.

U.S. Pat. No. 3,937,001 describes a clockwork that is driven by a spring and controlled by an electronic circuit. One embodiment described in said patent specification, comprises a generator having a rotor that is active like a balance wheel and together with a spiral spring forms a mechanical oscillator. The mechanical oscillator provides a periodic regular reciprocal motion for controlling the clockwork's speed.

The clockwork according to U.S. Pat. No. 3,937,001 is furthermore provided with a mechanism for automatically winding up the spring. Said mechanism comprises an eccentric pendulum weight (central rotor 29) that is able to move along a circular path in the clockwork. In case of a change of the spatial orientation of the clockwork, the pendulum weight will move to the lowest point of its path due to gravity. Said motion is used to wind up the drive spring. A comparable mechanism for winding up the drive spring is shown in US patent application 2005/0041535. Here again use is made of a pendulum weight (oscillating weight 51). The pendulum weight is driven by a change of the spatial orientation, in case of wristwatch for instance by an incidental arm movement of the wearer of the watch, and in general has no periodic regular motion.

It is an object of the invention to provide a mechanical clockwork assembly having improved stability and/or a more efficient use of the mechanical energy of the drive mechanism.

### SUMMARY OF THE INVENTION

According to a first aspect the invention for that purpose provides a mechanical clockwork assembly, comprising a drive mechanism, a mechanical control device comprising a mechanical oscillator and a first transmission device for providing a transmission between the drive mechanism and the mechanical oscillator, an electric generator and a second transmission device for providing a transmission between the drive mechanism and the generator, wherein the generator is spaced apart from the mechanical oscillator.

In the mechanical clockwork assembly according to the invention the drive mechanism drives both the mechanical oscillator via the first transmission device, as well as the generator, which is spaced apart from the mechanical oscillator, via the second transmission device in parallel. Due to this parallel drive the second transmission device can be optimised for more effectively driving the generator, for more efficiently generating electric energy.

In one embodiment the mechanical clockwork furthermore comprises a sensor for determining a timing of the mechanical oscillator, an actuator for adapting a timing of the mechanical oscillator, and an electronic control device connected to the sensor and the actuator, wherein the control device comprises an entry for a reference signal and wherein the control device is adapted for controlling the timing of the mechanical oscillator on the basis of the reference signal, wherein at least the control device is connected to the generator for supplying the control device with electric energy from the generator. In this way this embodiment of the clockwork assembly according to the invention is on the one hand provided with an electronic control for controlling the timing of the mechanical oscillator.

At least the control device is supplied with the electric energy from the generator. In one embodiment the sensor and/or actuator are also connected to be supplied with electric energy from the generator.

In one embodiment the clockwork assembly further comprises a crystal oscillator, preferably a quartz oscillator, connected to the entry of the control device, for providing the reference signal. By controlling the timing of the mechanical oscillator on the basis of an accurate crystal oscillator, such as for instance a quartz oscillator, a highly improved stability of the timing of the mechanical oscillator can be achieved. In one embodiment the crystal oscillator is connected to be supplied with electric energy from the generator.

In a further embodiment the clockwork assembly further comprises a receiver connected to the entry of the control device for wireless reception of the reference signal. In one embodiment the receiver is adapted for radiographic reception of a time signal. The timing of the mechanical oscillator can be controlled and/or regularly calibrated to a time signal, for instance from an atomic clock, that is transmitted via a radio transmitter. An example of such a time signal is the so-called “DCF-radio time signal”. In one embodiment the receiver is connected to be supplied with electric energy from the generator.

In a simple embodiment the second transmission device is at least partially connected in parallel to the first transmission device. A part of the first transmission device and a part of the second transmission device may in that case coincide. The first and second transmission device may utilise a common transmission member, which has preferably been placed at the side of the drive mechanism.

In one embodiment the first transmission device comprises an escapement wheel and an anchor cooperating therewith, wherein the escapement wheel is operatively connected to the drive mechanism and the anchor is operatively connected to the mechanical oscillator.

In one embodiment the sensor and/or the actuator comprise a magnet and a coil placed close to the magnet, wherein the magnet is operatively connected to the escapement wheel, the anchor or the mechanical oscillator, wherein the magnet due to a movement of the escapement wheel, the anchor or the mechanical oscillator is movable with respect to the coil. Due to the escapement wheel, the anchor or the mechanical oscillator moving the magnet with respect to the coil, the coil is subjected to a changing magnetic field, which as a result will influence the coil with a same timing as the timing of the mechanical oscillator. On the basis of signals from the coil the timing of the mechanical oscillator can be determined and in the electronic control circuit be compared to the timing of the reference signal. The sensor is therefore formed by the combination of a magnet and a coil.

If the timing of the mechanical oscillator runs ahead of the timing of the reference signal the coil can be connected for decelerating the magnet, for instance by short-circuiting the coil. If the timing of the mechanical oscillator runs behind the timing of the reference signal, the coil can be controlled for accelerating the magnet, for instance by sending a periodic current or current pulses through the coil. The combination of the magnet and the coil thus also forms the actuator.

In one embodiment the magnet is placed on the escapement wheel. When operative the escapement wheel makes a rotary motion, wherein the magnet in each revolution of the escapement wheel is moved past the coil. A current pulse is then generated in the coil with a frequency corresponding with the rotation frequency of the escapement wheel. In one embodiment the escapement wheel may be provided with several magnets, wherein each magnet is capable of generating a current pulse in the coil.

In one embodiment the magnet is placed on the anchor or the mechanical oscillator. When operative the magnet now carries out an oscillating motion. When the coil is placed near the centre of the oscillating motion, the magnet will generate current pulses in the coil having double the frequency of the frequency of the oscillating motion.

In one embodiment the sensor and/or actuator comprises two adjacent magnets, wherein the magnets are oriented with opposite earth poles to the coil. Due to this embodiment an alternating current signal is generated in the coil having a timing that is a measure for the timing of the mechanical oscillator. On the basis of the measurements of the alternating current or a quantity derived therefrom, for instance an alternating voltage over a resistance through which the alternating current at least partially runs, the timing of the mechanical oscillator can be determined and can be compared in the electronic control circuit to the timing of the reference signal.

In one embodiment the mechanical oscillator comprises a balance wheel placed so as to be rotatable on a first axis and a device for exerting a backward driving force on the balance wheel that is substantially proportional to a deflection of the balance wheel from a balance position. In one embodiment the device comprises a first resilient body, particularly a spiral spring, wherein the first resilient body with a first end is connected to the balance wheel or the first axis and with a second end is connected to a frame or housing of the clockwork assembly. In one embodiment the magnet is operatively connected to the balance wheel or the first axis. In one embodiment the magnet has been placed near the circumferential edge of the balance wheel thereon. By placing the magnet near the circumferential edge the coil, using relatively little force, is nonetheless capable of exerting large torque on the balance wheel to bring the timing of the balance wheel in conformity with the timing of the crystal oscillator.

In one embodiment the actuator is operatively connected to the first resilient body for adapting a spring constant of the first resilient body. In one embodiment the actuator comprises means for adapting the length of the first resilient body.

In one embodiment the sensor registers the timing of the mechanical oscillator on the basis of a varying reluctance or varying capacity.

In one embodiment the clockwork assembly comprises a storage device for electric energy, and particularly a capacitor or rechargeable battery, for at least temporarily storing electric energy originating from the generator. The battery may then serve as energy source for the various electronic components.

In a simple embodiment the drive mechanism comprises a second resilient body for driving the clockwork. The drive mechanism may in that case comprise a manual operating device, particularly a crown, for winding up the second resilient body. Instead of or in combination therewith the drive mechanism may comprise an eccentric pendulum weight which via a mechanical rectifier is connected to the second resilient body for winding up the second resilient body in case of a movement of the eccentric pendulum weight.

In one embodiment the second transmission device comprises a first and a second element that have been placed so as to be rotatable with respect to each other, wherein the first element is drivably connected to the drive mechanism and wherein the generator is drivably connected to the second element, and wherein the second transmission device comprises a third resilient body which with a first end is fixedly connected to the first element and with a second end is fixedly connected to the second element. The clockwork assembly is provided with a generator having a separate resilient transmission, as a result of which the generator during short periods can be driven with a relatively high angular speed and thus is capable of providing a high voltage. Not only does such a generator have a better efficiency for generating electric energy, but it is also advantageous in combination with a storage device for electric energy, particularly a capacitor or rechargeable battery, for storing electric energy coming from the generator and for feeding the control device, the sensor and/or the actuator. The voltage generated by the generator can be used for recharging the storage device, if this voltage exceeds a minimum loading voltage determined by the storage device.

In one embodiment the generator comprises a rotor wheel connected to a driving shaft which rotor wheel is provided with magnetic earth poles and a stator having a number of windings, for supplying electric voltage. Due to the restraining torque between the rotor wheel and the stator, the rotor wheel is retained with respect to the stator in one of its rest positions. The drive mechanism will wind up the third resilient body, wherein the speed of winding up preferably is controlled by the mechanical oscillator, until the moment on which the spring force of the third resilient body becomes substantially equal to the restraining torque of the generator. At that moment the restraining torque is no longer able to hold the rotor wheel, wherein the potential energy stored in the third resilient body is released for accelerating the rotor wheel.

As an alternative for the restraining torque of the generator one embodiment of the clockwork assembly further comprises a blocking device that engages onto the second element for blocking a rotation of the second element, wherein the blocking mechanism is drivably coupled to the mechanical oscillator for periodically releasing the second element for driving the generator and subsequently blocking the rotation of the second element again. In this embodiment stopping the rotor wheel is independent of the restraining torque of the generator. On the one hand a generator having a small restraining torque can thus be utilised. On the other hand the third resilient body can be wound up to a spring force exceeding the restraining torque. Due to the higher spring force the acceleration of the rotor wheel may be higher, and the generator is thus able to supply a higher voltage.

According to a further aspect the invention provides a clock, particularly a watch, provided with a clockwork assembly as described above.

The aspects and measures described in this description and claims of the application and/or shown in the drawings of this application may where possible also be used individually. Said individual aspects, such as the control device, a second transmission device having a blocking mechanism that is drivably coupled to the mechanical oscillator, and an actuator for adapting a spring constant, particularly for adapting the length of the spring, and other aspects may be the subject of divisional patent applications relating thereto. This particularly applies to the measures and aspects that are described per se in the sub claims.

### SHORT DESCRIPTION OF THE DRAWINGS

The invention will be elucidated on the basis of a number of exemplary embodiments shown in the attached drawings, in which:

FIG. 1 shows a schematic view of an exemplary embodiment of a clockwork assembly according to the invention;

FIG. 2 shows a schematic view of a further exemplary embodiment of a transmission device for driving the generator; and

FIG. 3 shows a schematic view of a further exemplary embodiment of an actuator for adapting the timing of the mechanical oscillator.

### DETAILED DESCRIPTION OF THE DRAWINGS

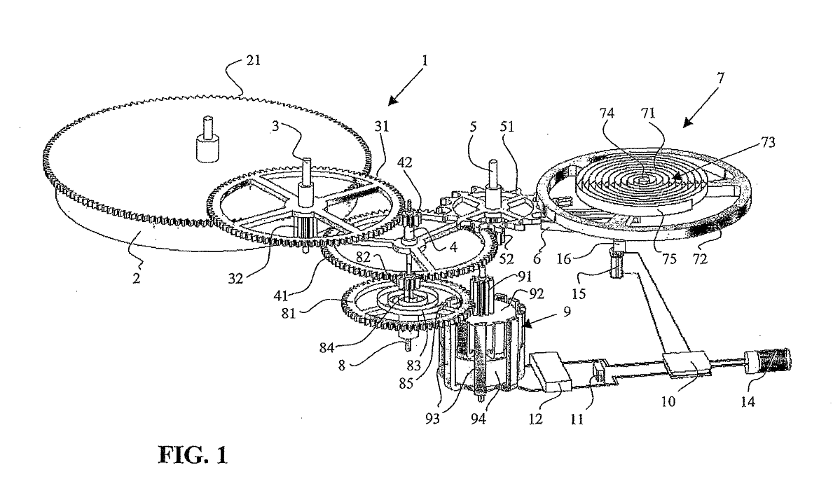

The exemplary embodiment of a clockwork assembly 1 as shown in FIG. 1, comprises a drive mechanism in the shape of a drum 2 having a spring (not shown) placed therein for driving the clockwork assembly 1. The spring may in the known manner be wound up via a manual operation or an eccentric pendulum weight.

The drum 2 has been provided with a gear wheel 21 coupled to a first transmission device comprising:
a first shaft 3 having a first gear wheel 31 and a first pinion 32, wherein the first gear wheel 31 and the first pinion 32 are rotation-fixedly connected to the shaft 3, wherein the gear wheel 21 of the drum 2 and the first pinion 32 mesh;
a second shaft 4 having a second gear wheel 41 and a second pinion 42, wherein the second gear wheel 41 and the second pinion 42 are rotation-fixedly connected to the shaft 4, wherein the first gear wheel 31 and the second pinion 42 mesh;
a third shaft 5 having an escapement wheel 51 and a third pinion 52, wherein the escapement wheel 51 and the third pinion 52 are rotation-fixedly connected to the shaft 5, wherein the second gear wheel 41 the third pinion 52 mesh; and
an anchor 6 cooperating with the escapement wheel 51 and operatively connected to the mechanical oscillator 7.

The mechanical oscillator 7 comprises a balance wheel 72 that is rotation-fixedly connected to a fourth shaft 71, which balance wheel is able to carry out an oscillating rotary motion around said shaft 71. The oscillator 7 further comprises a spiral spring 73 which with a first end 74 is connected to the fourth shaft 71 or the balance wheel 72, and with another end 75 can be connected to a frame or housing of the clockwork (not shown).

The clockwork assembly 1 is furthermore provided with a second transmission device comprising:
the first shaft 3 having the first gear wheel 31 and the first pinion 32, wherein the first gear wheel 31 and the first pinion 32 are rotation-fixedly connected to the shaft 3, wherein the gear wheel 21 of the drum 2 and the first pinion 32 mesh;
the second shaft 4 having the second gear wheel 41 and the second pinion 42, wherein the second gear wheel 41 and the second pinion 42 are rotation-fixedly connected to the shaft 4, wherein the first gear wheel 31 and the second pinion 42 mesh;
a fifth shaft 8 having a fifth pinion 82, wherein the fifth pinion 82 is rotation-fixedly connected to the shaft 8, wherein the second gear wheel 41 the fifth pinion 82 mesh;
a fifth gear wheel 81 that is placed on the fifth shaft 8 so as to be rotatable, wherein the fifth gear wheel 81 and the fifth shaft 8 are connected one to the other with a spiral spring 83, wherein the first end 84 of the spiral spring 83 is fixedly connected to the fifth shaft 8, and a second end 85 of the spiral spring 83 which end faces away from the first end 84 is fixedly connected to the fifth gear wheel 81; and
wherein the fifth gear wheel 81 and a pinion 91 mesh on the axis of rotation of a generator 9 for coupling the generator 9 to the drive mechanism 2. The second transmission device is at least partially dissimilar to the second transmission; after the second gear wheel 41 the transmission is divided into two parallel branches that ensure the transmission with the mechanical oscillator 7 on the one hand and the generator 9 on the other hand, respectively.

The microgenerator 9 comprises a multi-earth pole magnet 92, for instance a resin-bound Sm₂Co₁₇ magnet having fourteen earth poles, that is rotation-fixedly connected to the axis of rotation. The generator 9 furthermore comprises a stator 93 having claw-shaped earth poles that envelop a coil 94.

The exemplary embodiment of FIG. 1 further comprises an electronic control device 10, particularly in the form of an integrated circuit (IC). The control device 10 is supplied by an accumulator 11, in the form of a capacitor. Such a capacitor typically has a capacity of 10 micro Farad. Via a rectifier 12, the accumulator 11 is connected to the generator 9 for charging the accumulator 11 when the generator 9 is driven.

The control device 10 is on the one hand connected to a device 14 for providing a reference signal, particularly a quartz oscillator or a receiver for a time signal. On the other hand the control device 10 is connected to a coil 15 placed near a magnet 16. The coil 15 and the magnet 16 form the sensor and actuator for controlling the timing of the mechanical oscillator 7.

The magnet 16 has been placed near a circumferential edge on the balance wheel 72. In the rest position of the mechanical oscillator 7, the coil 15 is placed near the magnet 16. When the clockwork 1 ticks the balance wheel 72 will carry out an oscillating rotary motion and thus reciprocally move the magnet 16 along the coil 15.

The coil 15 is electrically connected to a control 10 which compares the timing of a current in the coil 15 induced by the magnet 16 to the timing of the reference signal of for instance a quartz oscillator 14. If the timing of the induced current deviates from the timing of the quartz oscillator 14, the control 10 is able to subsequently decelerate or accelerate the motion of the magnet 16 by means of the coil 15, for substantially controlling the timing of the mechanical oscillator 7 to be equal to the timing of the quartz oscillator 14.

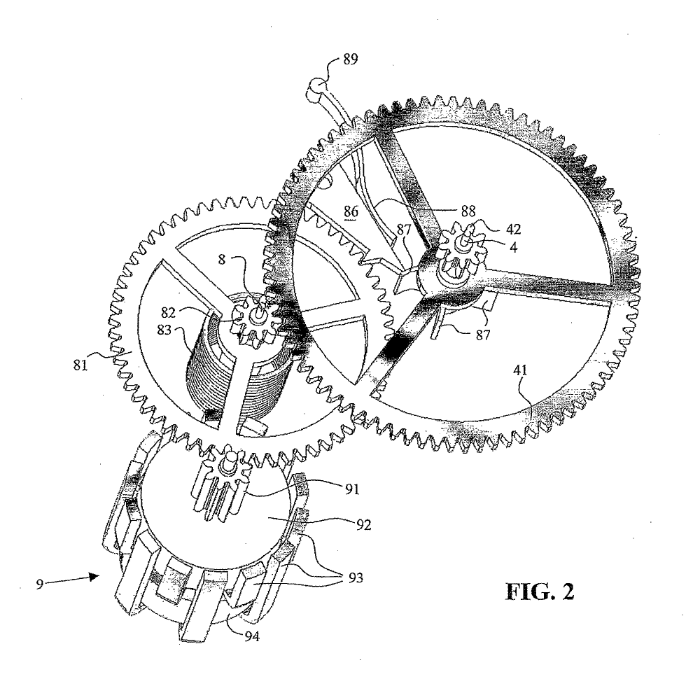

In the exemplary embodiment of FIG. 1 the rotor wheel 92 is retained with respect to the stator 93 in one of its rest positions, due to the restraining torque between the rotor wheel 92 and the stator 93. In an alternative exemplary embodiment, as shown in FIG. 2, the clockwork assembly is provided with a blocking mechanism in the form of a pawl 86, that engages onto the fifth gear wheel 81 for blocking a rotation of said fifth gear wheel 81. A spring 89 pushes with a first end 88 against the pawl 86, so that it retains the fifth gear wheel 81 when in the rest position. In said position the drive mechanism 2 will drive the fifth pinion 82 via the second transmission device, as a result of which the spring 83 can be wound up.

In this exemplary embodiment a number of cams 87 have been placed on the second shaft 4. The second shaft 4 is coupled with the mechanical oscillator 7 via the anchor 6, the escapement wheel 51 and the third pinion 52. Thus the rotation of the second shaft 4 is regulated by the timing of the mechanical oscillator 7. The cams 87 have been rotary-fixedly placed on the second shaft 4 and during rotation of the second shaft 4 will periodically push away the pawl 86, as a result of which the pawl 86 no longer retains the fifth gear wheel 81 for a certain period of time. During this period of time the spring 83 is able to drive the rotor wheel 92 for generating electric energy. In the exemplary embodiment of FIG. 2, resilient cams 87 are used that push away the pawl 86, keep the pawl 86 pushed away for a certain period of time and during this time elastically bend through and subsequently release the pawl 86, after which the pawl 86 returns to its rest position and blocks the rotation of the fifth gear wheel 81.

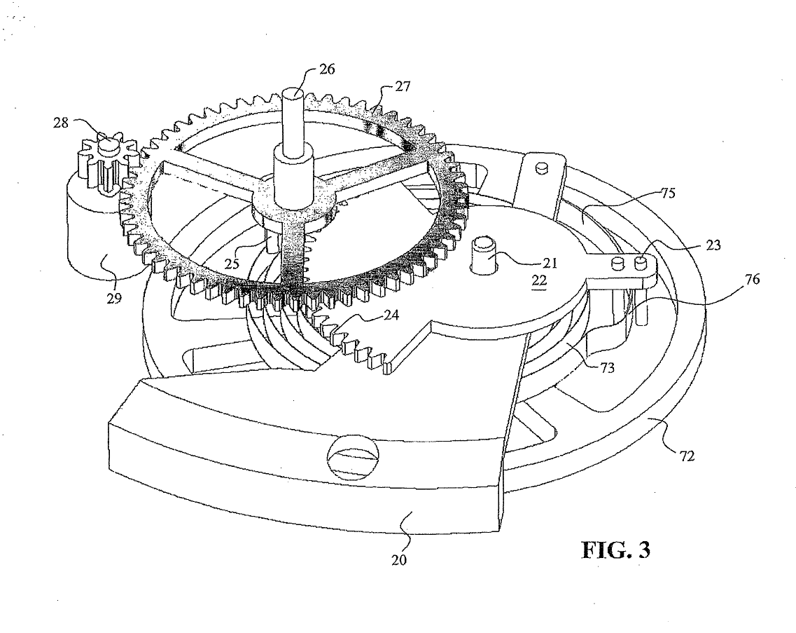

In the exemplary embodiment of FIG. 1 the coil 15 and the magnet 16 form the actuator for adapting the timing of the mechanical oscillator 7. In an alternative exemplary embodiment, as shown in FIG. 3, an actuator is operatively connected to the spiral spring 73 of the mechanical oscillator 7 for adapting the spring constant of the spiral spring 73. Said embodiment of the actuator comprises means for adapting the length of the spiral spring 73.

For that purpose the end 75 of the spiral spring 73 is fixedly connected to a frame or housing member 20 of the clockwork. The housing member 20 has been provided with a shaft 21 and a tooth segment 22 placed on the shaft 21 so as to be rotatable, with a holder 23 for the spiral spring 73 placed at a side facing away from the teeth 24. Due to rotation of the tooth segment 22 with respect to the housing member 20 the position where the holder 23 engages onto the spiral spring 73 and thus the length of the spiral spring 73, can be set. The rotation of the tooth segment 22 is ensured by an electromotor 29 that drives a gear wheel 27 by means of a pinion. The gear wheel 27 is rotation-fixedly connected to a shaft 26 and a pinion 25 placed on said shaft 26, wherein the pinion 25 and the toothed segment 22 mesh.

The above description is included to illustrate the operation of preferred embodiments of the invention and not to limit the scope of the invention. Starting from the above explanation many variations that fall within the spirit and scope of the present invention will be evident to an expert.

1. Mechanical clockwork assembly, comprising
a drive mechanism,
a mechanical control device comprising a mechanical oscillator,
a first transmission device for providing a transmission between the drive mechanism and the mechanical oscillator,
an electric generator, and
a second transmission device for providing a transmission between the drive mechanism and the generator,
wherein the generator is spaced apart from the mechanical oscillator.

2. Clockwork assembly according to claim 1, comprising
a sensor for determining a timing of the mechanical oscillator,
an actuator for adapting a timing of the mechanical oscillator, and
an electronic control device connected to the sensor and the actuator, wherein the control device comprises an entry for a reference signal and wherein the control device is adapted for controlling the timing of the mechanical oscillator on the basis of the reference signal, wherein at least the control device is connected to the generator for supplying the control device with electric energy from the generator.

3. Clockwork assembly according to claim 2, wherein the sensor and/or actuator are connected to be supplied with electric energy from the generator.

4. Clockwork assembly according to claim 2, wherein the clockwork further comprises a crystal oscillator connected to the entry of the control device, for providing the reference signal.

5. Clockwork assembly according to claim 4, wherein the crystal oscillator comprises a quartz oscillator.

6. Clockwork assembly according to claim 4, wherein the crystal oscillator is connected to be supplied with electric energy from the generator.

7. Clockwork assembly according to claim 2, wherein the clockwork further comprises a receiver connected to the entry of the control device for wireless reception of the reference signal.

8. Clockwork assembly according to claim 7, wherein the receiver is adapted for radiographic reception of a time signal.

9. Clockwork assembly according to claim 7, wherein the receiver is connected to be supplied with electric energy from the generator.

10. Clockwork assembly according to claim 1, wherein the second transmission device is at least partially connected in parallel to the first transmission device.

11. Clockwork assembly according to claim 1, wherein the first transmission device comprises an escapement wheel and an anchor cooperating therewith, wherein the escapement wheel is operatively connected to the drive mechanism and the anchor is operatively connected to the mechanical oscillator.

12. Clockwork assembly according to claim 11, wherein the mechanical oscillator comprises a balance wheel placed so as to be rotatable on a first axis and a device for exerting a backward driving force on the balance wheel that is substantially proportional to a deflection of the balance wheel from a balance position.

13. Clockwork assembly according to claim 12, wherein the device comprises a first resilient body, particularly a spiral spring, wherein the first resilient body with a first end is connected to the balance wheel or the first axis and with a second end is connected to a frame or housing of the clockwork assembly.

14. Clockwork assembly according to claim 12, wherein the sensor and/or actuator comprise a magnet and a coil placed close to the magnet, wherein the magnet is operatively connected to the escapement wheel, the anchor or the mechanical oscillator, wherein the magnet due to a movement of the escapement wheel, the anchor or the mechanical oscillator is movable with respect to the coil.

15. Clockwork assembly according to claim 14, wherein the magnet is placed on the balance wheel and wherein the coil is connected to the frame or the housing of the clockwork assembly.

16. Clockwork assembly according to claim 15, wherein the magnet has been placed near a circumferential edge of the balance wheel.

17. Clockwork assembly according to claim 13, wherein the actuator is operatively connected to the first resilient body for adapting a spring constant of the first resilient body.

18. Clockwork assembly according to claim 17, wherein the actuator comprises means for adapting the length of the first resilient body.

19. Clockwork assembly according to claims 2, wherein at least the sensor registers the timing of the mechanical oscillator on the basis of a varying reluctance or capacity.

20. Clockwork assembly according to claim 1, further comprising a storage device for electric energy, and particularly a capacitor or rechargeable battery, for at least temporarily storing electric energy originating from the generator.

21. Clockwork assembly according to claim 1, wherein the drive mechanism comprises a second resilient body for driving the clockwork.

22. Clockwork assembly according to claim 21, wherein the drive mechanism comprises a manual operating device, particularly a crown, for winding up the second resilient body.

23. Clockwork assembly according to claim 21, wherein the drive mechanism comprises an eccentric pendulum weight which via a mechanical rectifier is connected to the second resilient body for winding up the second resilient body in case of a movement of the eccentric pendulum weight.

24. Clockwork assembly according to claim 1, wherein the second transmission device comprises a first and a second element that have been placed so as to be rotatable with respect to each other, wherein the first element is drivably connected to the drive mechanism and wherein the generator is drivably connected to the second element, and wherein the second transmission device comprises a third resilient body which with a first end is fixedly connected to the first element and with a second end is fixedly connected to the second element.

25. Clockwork assembly according to claim 24, further comprising a blocking device that engages onto the second element for blocking a rotation of the second element, wherein the blocking mechanism is drivably connected to the mechanical oscillator for periodically releasing the second element for driving the generator and subsequently blocking the rotation of the second element again.

26. Clock, particularly a watch, provided with a clockwork assembly according to claim 1.

27. (canceled)

28. (canceled)
